(19) United States
(12) Patent Application Publication
(10) Pub. No.: US 2025/0138988 A1
(43) Pub. Date: May 1, 2025

(54) MACHINE LEARNING METHOD FOR ASSOCIATING TEST FILES WITH SOURCE CODE

(71) Applicant: Dell Products L.P., Round Rock, TX (US)

(72) Inventors: Owen Orakwue, Westford, MA (US); David Sydow, Merrimack, NH (US)

(73) Assignee: Dell Products L.P., Round Rock, TX (US)

(21) Appl. No.: 18/385,944

(22) Filed: Nov. 1, 2023

(51) Int. Cl. G06F 11/36

(52) U.S. Cl. CPC G06F 11/3688

(57) ABSTRACT

Methods, system, and non-transitory processor-readable storage medium for a source code file association system are provided herein. An example method includes receiving, by a project management tool associated with a software test lifecycle system, a pull request to merge software code changes with a software project repository on an enterprise system. The software testing life cycle system executes a plurality of integration test suites associated with the pull request on at least one test system associated with the enterprise system. The integration test suites are executed to test the software code changes. The project management tool captures the integration test suite output. A source code file association system preprocesses the integration test suite output for input into a machine learning system. The integration test suite output is encoded. The output of the machine learning system identifies at least a portion of source code exercised by the integration test suites.

### FIELD

The field relates generally to associating test files with source code, and more particularly to associating integration test suites with source code files in information processing systems.

### BACKGROUND

During the lifecycle of complex software system development, many tests are performed to ensure high quality and effective functionality. New features are added incrementally to previous software releases. Regression and/or integration test suites are executed to ensure the new code changes have not introduced new problems. There may be thousands of regression or integration test suites for complicated information processing systems, such as storage products and enterprise systems.

### SUMMARY

Illustrative embodiments provide techniques for implementing a source code file association system in a storage system. For example, illustrative embodiments receive, by a project management tool associated with a software test lifecycle system, a pull request to merge software code changes with a software project repository on an enterprise system. The software testing life cycle system executes a plurality of integration test suites associated with the pull request on at least one test system associated with the enterprise system. The integration test suites are executed to test the software code changes. In response to the execution of the integration test suites, the project management tool captures the integration test suite output. A source code file association system preprocesses the integration test suite output into preprocessed data for input into a machine learning system, where the integration test suite output is encoded. The source code file association system receives, as output of the machine learning system, identification of at least a portion of source code exercised by the integration test suites. Other types of processing devices can be used in other embodiments. These and other illustrative embodiments include, without limitation, apparatus, systems, methods and processor-readable storage media.

### BRIEF DESCRIPTION OF THE DRAWINGS

FIG. 1 shows an information processing system including a source code file association system in an illustrative embodiment.

FIG. 2 shows a flow diagram of a process for a source code file association system in an illustrative embodiment.

FIG. 3. illustrates a high-level overview of a strategy to infer which integration test suites are exercising specific source code files, in an illustrative embodiment.

FIGS. 4 and 5 show examples of processing platforms that may be utilized to implement at least a portion of a source code file association system embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Described below is a technique for use in implementing a source code file association system, which technique may be used to provide, among other things associating source code file with integration test suites in an enterprise storage system by receiving, by a project management tool associated with a software test lifecycle system, a pull request to merge software code changes with a software project repository on an enterprise system. The software testing life cycle system executes a plurality of integration test suites associated with the pull request on at least one test system associated with the enterprise system. The integration test suites are executed to test the software code changes. In response to the execution of the integration test suites, the project management tool captures the integration test suite output. A source code file association system preprocesses the integration test suite output into preprocessed data for input into a machine learning system, where the integration test suite output is encoded. The source code file association system receives, as output of the machine learning system, identification of at least a portion of source code exercised by the integration test suites.

Complex enterprise products may have tens of millions of lines of code built into a given delivery. In any organization with such a large code base, there are typically multiple teams developing test suites to validate code changes for both individual code deliveries, as well as to validate entire releases. For both release and individual code deliveries, it is necessary to develop and run an integration test suite that will test high level functionality of the enterprise system. These integration test suites often test a significant number of different code paths and interactions, which are often not fully recognized. For example, a “read-only” test designed to run a diagnostic suite on a large system may run a CPU intensive operation which will exercise custom code on the system OS Kernel that can, in turn, affect availability of the external system Graphical User Interface sharing the same CPU. This type of integration test suite is in opposition to a unit test suite which is very focused on a well-defined and understood set of code paths.

Conventional technologies related to integration test suites do not provide users with information regarding the specific source code exercised when the integration test suites are executed. Integration test suites take a long time to run, potentially causing a significant delay in the delivery process for individual code changes if every integration test suite must be run. Conventional technologies do not associate integration test suites with the source code files exercised by the execution of those integration test suites. Conventional technologies do not identify integration test suites so as to execute only those integration test suites that target the source code affected by those individual code changes. Conventional technologies do not provide a way to facilitate a more efficient Continuous Integration and Continuous Delivery/Deployment (CI/CD) lifecycle for individual code changes. Conventional technologies do not provide a mapping between the integration test suites, which often test very broad and complex functionality, and the associated source code files. Conventional technologies require execution of all the integration test suites in the CI/CD suite, regardless of the source code under test. Conventional technologies do not dynamically map the executed integration test suites to the source code exercised by those executed integration test suites, as those integration test suites are executed.

By contrast, in at least some implementations in accordance with the current technique as described herein a source code file association system is implemented by receiving, by a project management tool associated with a software test lifecycle system, a pull request to merge software code changes with a software project repository on an enterprise system. The software testing life cycle system executes a plurality of integration test suites associated with the pull request on at least one test system associated with the enterprise system. The integration test suites are executed to test the software code changes. In response to the execution of the integration test suites, the project management tool captures the integration test suite output. A source code file association system preprocesses the integration test suite output into preprocessed data for input into a machine learning system, where the integration test suite output is encoded. The source code file association system receives, as output of the machine learning system, identification of at least a portion of source code exercised by the integration test suites. The current technique comprises a three-step process; Data Wrangling, Training, and Inference, which is described in further details below.

Thus, a goal of the current technique is to provide a method and a system for associating integration test suites with the source code files exercised by the execution of those integration test suites. Another goal is to dynamically map the executed integration test suites to the source code exercised by those executed integration test suites, as those integration test suites are executed. Another goal is to provide users with information regarding the specific source code exercised when the integration test suites are executed. Another goal is to identify integration test suites so as to execute only those integration test suites that target the source code affected by individual code changes. Another goal is to facilitate a more efficient Continuous Integration and Continuous Delivery/Deployment (CI/CD) lifecycle for individual code changes. Yet another goal is to provide a mapping between the integration test suites, which often test very broad and complex functionality, and the associated source code files.

In at least some implementations in accordance with the current technique described herein, the use of a source code file association system can provide one or more of the following advantages: dynamically map the executed integration test suites to the source code exercised by those executed integration test suites, as those integration test suites are executed, provide a method and a system for associating integration test suites with the source code files exercised by the execution of those integration test suites, provide users with information regarding the specific source code exercised when the integration test suites are executed, identify integration test suites so as to execute only those integration test suites that target the source code affected by individual code changes, facilitate a more efficient Continuous Integration and Continuous Delivery/Deployment (CI/CD) lifecycle for individual code changes and provide a mapping between the integration test suites, which often test very broad and complex functionality, and the associated source code files.

In contrast to conventional technologies, in at least some implementations in accordance with the current technique as described herein, herein integration test suites are mapped to the associated source code files, by receiving, by a project management tool associated with a software test lifecycle system, a pull request to merge software code changes with a software project repository on an enterprise system. The software testing life cycle system executes a plurality of integration test suites associated with the pull request on at least one test system associated with the enterprise system. The integration test suites are executed to test the software code changes. In response to the execution of the integration test suites, the project management tool captures the integration test suite output. A source code file association system preprocesses the integration test suite output into preprocessed data for input into a machine learning system, where the integration test suite output is encoded. The source code file association system receives, as output of the machine learning system, identification of at least a portion of source code exercised by the integration test suites.

In an example embodiment of the current technique, the project management tool detects that at least one new integration test suite has been added to the plurality of integration test suites, and in response, performs the steps of executing, capturing, preprocessing, and receiving.

In an example embodiment of the current technique, the software testing life cycle system executes a plurality of pull requests, where a respective plurality of integration test suites is iteratively executed for each pull request.

In an example embodiment of the current technique, the integration test suite output comprises failures detected in a plurality of source code files during the execution of the plurality of integration test suites.

In an example embodiment of the current technique, the source code file association system exercises a remote API on a software repository to obtain source code file information for each of the plurality of source code files.

In an example embodiment of the current technique, the source code file information comprises at least one of source code file name, a path of the source code file in the software repository, a file type associated with the source code file name, and at least one source code repository name.

In an example embodiment of the current technique, the source code file association system performs one-hot encoding on the source code file information.

In an example embodiment of the current technique, the source code file association system obtains integration test suite information comprising at least one of test name, test run status and pull request identifier.

In an example embodiment of the current technique, the source code file association system uses a pull request identifier to obtain the source code information.

In an example embodiment of the current technique, the source code file association system performs one-hot encoding on the test name.

In an example embodiment of the current technique, the source code file association system identifies a potential pattern of association between a subset of the plurality of source code files and the integration test suite output.

In an example embodiment of the current technique, the source code file association system combines source code file information and integration test suite information into the preprocessed data and trains the machine learning system with the preprocessed data.

In an example embodiment of the current technique, the source code file association system trains the machine learning system with a subset of the preprocessed data, and validates the machine learning system with a remaining subset of the preprocessed data, where the preprocessed data comprises the subset of the preprocessed data and the remaining subset of the preprocessed data.

In an example embodiment of the current technique, the source code file association system runs inference on the preprocessed data, using a weighted ensemble model to identify the portion of source code exercised by the integration test suites.

In an example embodiment of the current technique, the portion of source code comprises a plurality of source code files, and the output of the machine learning system associates at least one of the plurality of source code files exercised by at least one integration test suite, where the integration test suites comprise at least one integration test suite.

In an example embodiment of the current technique, the weighted ensemble model is an AutoGluon weighted ensemble model.

In an example embodiment of the current technique, the source code file association system tunes the weighted ensemble model with at least one of a max-base models parameter, a num_folds_parallel parameter, a max_base_models_per_type parameter, a use_orig_features parameter, a save_bag_folds parameter, and a fold_fitting_strategy parameter.

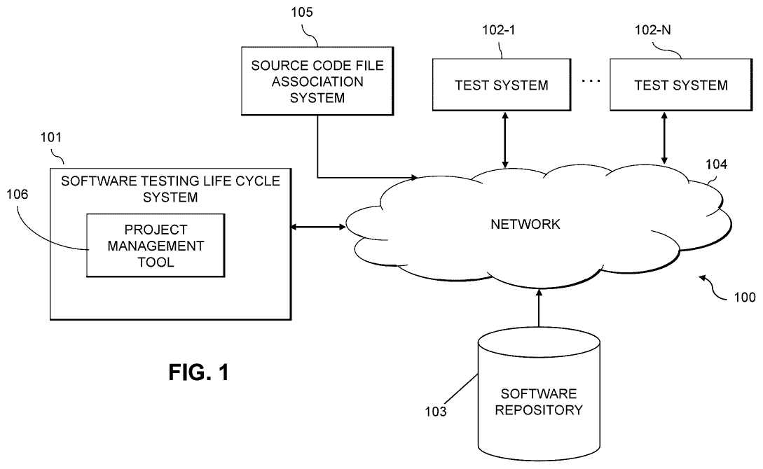

FIG. 1 shows a computer network (also referred to herein as an information processing system) 100 configured in accordance with an illustrative embodiment. The computer network 100 comprises a software testing life cycle system 101, project management tool 106, source code file association system 105, software repository 103, and test systems 102-N. The software testing life cycle system 101, project management tool 106, source code file association system 105, software repository 103, and test systems 102-N are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a source code file association system 105 that may reside on a storage system. Such storage systems can comprise any of a variety of different types of storage including network-attached storage (NAS), storage area networks (SANs), direct-attached storage (DAS) and distributed DAS, as well as combinations of these and other storage types, including software-defined storage.

Each of the test systems 102-N may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The test systems 102-N in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the source code file association system 105 are one or more input-output devices, which illustratively comprise keyboards, displays or other types of input-output devices in any combination. Such input-output devices can be used, for example, to support one or more user interfaces to the source code file association system 105, as well as to support communication between the source code file association system 105 and other related systems and devices not explicitly shown. For example, a dashboard may be provided for a user to view a progression of the execution of the source code file association system 105. One or more input-output devices may also be associated with any of the test systems 102-N.

Additionally, the source code file association system 105 in the FIG. 1 embodiment is assumed to be implemented using at least one processing device. Each such processing device generally comprises at least one processor and an associated memory, and implements one or more functional modules for controlling certain features of the source code file association system 105.

More particularly, the source code file association system 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the source code file association system 105 to communicate over the network 104 with the software testing life cycle system 101, the project management tool 106, software repository 103, and test systems 102-N and illustratively comprises one or more conventional transceivers.

A source code file association system 105 may be implemented at least in part in the form of software that is stored in memory and executed by a processor, and may reside in any processing device. The source code file association system 105 may be a standalone plugin that may be included within a processing device.

It is to be understood that the particular set of elements shown in FIG. 1 for source code file association system 105 involving the software testing life cycle system 101, project management tool 106, software repository 103, and test systems 102-N of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the source code file association system 105 can be on and/or part of the same processing platform.

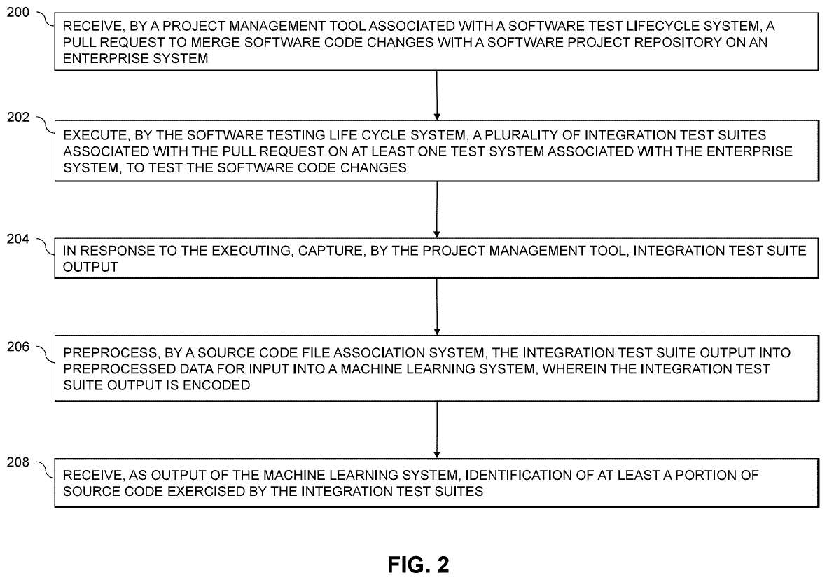

An exemplary process of source code file association system 105 in computer network 100 will be described in more detail with reference to, for example, the flow diagram of FIG. 2. FIG. 2 is a flow diagram of a process for execution of the source code file association system 105 in an illustrative embodiment. It is to be understood that this particular process is only an example, and additional or alternative processes can be carried out in other embodiments.

At 200, a project management tool 106 associated with a software test lifecycle system 101 receives a pull request to merge software code changes with a software project repository 103 on an enterprise system. For example, a bug fix pull request may have minor software code changes, as compared to a release bubble pull request or a feature merge pull request.

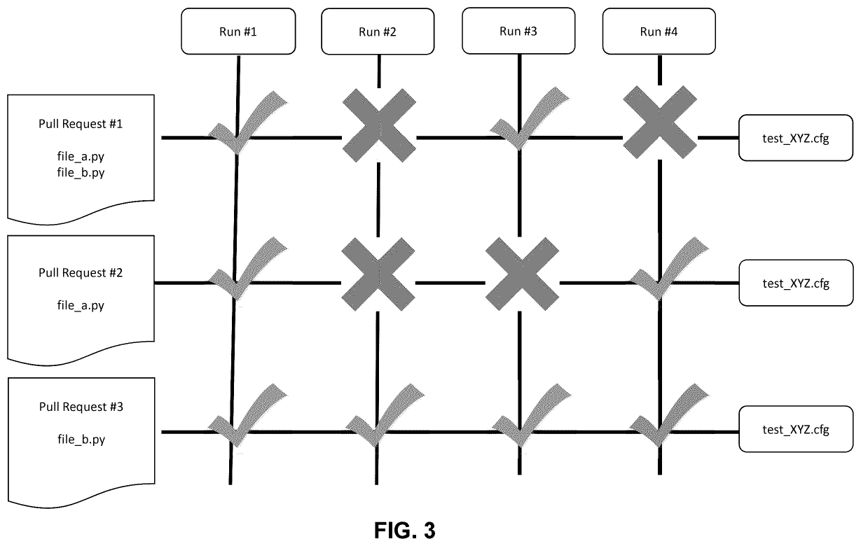

At 202, the software testing life cycle system 101 executes a plurality of integration test suites associated with the pull request on at least one test system associated with the enterprise system, to test the software code changes. For example, FIG. 3 illustrates an example of a strategy used to determine, over the course of 4 test runs, that file_a.py is exercised by test_XYZ.cfg. In an example embodiment, the software testing life cycle 101 executes a plurality of pull requests, where a respective plurality of integration test suites is iteratively executed for each pull request. Referring to FIG. 3, in Pull Request #1, files file_a.py and file_b.py are executed, in Pull Request #2, file file_a.py is executed, and in Pull Request #3, file_b.py is executed. In an example embodiment, the integration test suite output comprises failures detected in a plurality of source code files during the execution of the plurality of integration test suites. For example, in Pull Request #1→Run 1 no failures occur, so it is not possible to determine which file, if any, is exercised by test_XYZ.cfg. In Pull Request #1→Run 2, a failure occurs against file_a.py and file_b.py, so both are possible candidates to be associated with test_XYZ.cfg. In Pull Request #2→Run 2, a failure occurs against file_a.py, which makes it a likely candidate to be exercised by test_XYZ.cfg. In pull Request #2→Run 3, once again, a failure occurs against file_a.py, which strengthens the association. In pull Request #3, file_b.py tested alone has all passes, which does not eliminate file_b.py as possibly being associated with test_XYZ.cfg, but continues to strengthen that file_a.py is associated with test_XYZ.cfg.

At 204, the project management tool 106, in response to the execution of the plurality of integration test suites associated with at least one pull request, captures integration test suite output resulting from the execution. This step is referred to as Data Wrangling and requires the collection of the test failures and source code file information. In an example embodiment, the retention and collection of the test failures can be performed, for example, via remote Application Programming Interfaces (APIs) or via internal custom databases. In an example embodiment, the source code file association system 105 obtains integration test suite information comprising at least one of test name, test run status and pull request identifier. In an example embodiment, the source code file association system 105 uses the pull request identifier to obtain source code file information (for example, File Name, File Path, File Type, and File Repository) for every source code file under test. In an example embodiment, the source code file information is accessed via a source control API. For example, the pull request identifier is used when the integration test suite information is obtained from GitHub. The GitHub API provides this information under the “Get a pull request” API. In an example embodiment, the source code file association system 105 performs one-hot encoding on the test name. An example of the integration test suite information is illustrated below:

### Integration Test Suite Information

| Data | Description | Encoding |
|---|---|---|
| Test Name | Name of the Integration Test Suite | One Hot |
| Test Run Status | Path of the source code file in the | 0/1 |
| | repository | |
| Pull Request ID | Unique ID of the Pull Request | None |

In an example embodiment, the source code file association system 105 exercises a remote API on a software repository 103 to obtain source code file information for each of the plurality of source code files. In an example embodiment, the source code file information comprises at least one of source code file name, a path of the source code file in the software repository, a file type associated with the source code file name, at least one source code repository name. In an example embodiment, the source code file association system 105 performs one-hot encoding on the source code file information. An example of the source code file information is illustrated below:

### Source Code File Information

| Data | Description | Encoding |
|---|---|---|
| File Name | Name of the source code file | One Hot |
| File Path | Path of the source code file in the repository | One Hot |
| File Type | The file type: .py, .java, etc. | One Hot |
| File | The source code repository name if source code | One Hot |
| Repository | spans multiple repositories | |

At 206, the source code file association system 105 preprocesses the integration test suite output into preprocessed data for input into a machine learning system, where the integration test suite output is encoded. In an example embodiment, the source code file association system 105 combines source code file information and integration test suite information into the preprocessed data, and trains the machine learning system with the preprocessed data. The source code file association system 105 identifies a potential pattern of association between a subset of the plurality of source code files and the integration test suite output. Illustrated below is an example of the combined source code file information and the integration test suite information.

| Test Run Status | File | File | File | File | Test | |
|---|---|---|---|---|---|---|
| (Label) | Name | Path | Type | Repository | Name | Row |
| 1 | 1 | 1 | 3 | 2 | 1 | 1 |
| 1 | 2 | 1 | 3 | 2 | 1 | 2 |
| 1 | 2 | 1 | 3 | 2 | 2 | 3 |
| 0 | 2 | 1 | 3 | 2 | 3 | 4 |
| 1 | 3 | 2 | 1 | 4 | 3 | 5 |

In an example embodiment, the source code file association system 105 trains the machine learning system with a subset of the preprocessed data. This step is referred to as the Training step. In an example embodiment, the training and testing data is split, with 80% of the data used to train the machine learning system, and 20% of the data used to validate the machine learning system. One-Hot encoding is used to encode most of the data, as illustrated in the table above. The “Test Run Status” for each source code file is used as a label, with “0” representing a failed integration test, and 1 representing a passed integration test. When multiple source code files are under test for a single integration test, each source code file is represented as multiple rows in the data frame, as illustrated in rows 1 and 2 in the table above. The source code file association system 105 then validates the machine learning system with a remaining subset of the preprocessed data, where the preprocessed data comprises the subset of the preprocessed data and the remaining subset of the preprocessed data. In other words, in this example embodiment, the source code file association system 105 uses 80% of the data to train the machine learning system and the remaining 20% of the data to validate the trained machine learning system. In an example embodiment, the data used to train the machine learning system is saved by the project management tool 106, and stored in a format that can be utilized by the machine learning system. In an example embodiment, the training data is a mapping between the source code and errors detected by the integration test suites.

At 208, the source code file association system 105 receives, as output of the machine learning system, identification of at least a portion of source code exercised by the integration test suites. In an example embodiment, the portion of source code comprises a plurality of source code files that are identified as being exercised by the integration test suites. The output of the machine learning system associates at least one of the plurality of source code files exercised by at least one integration test suite, where the integration test suites comprise at least one integration test suite. In other words, the source code file association system 105 maps the individual integration test suite files to the source code files that are exercised during the execution of those individual integration test suite files. In an example embodiment, the identification of at least a portion of source code exercised by the integration test suites is dynamically generated during each pull request. In an example embodiment, the identification of at least a portion of source code exercised by the integration test suites is reported out to the project management tool 106.

In an example embodiment, the source code file association system 105 runs inference on the preprocessed data, using a weighted ensemble model to identify the portion of source code exercised by the integration test suites. This is referred to as the Inference step. In an example embodiment, the weighted ensemble model is an AutoGluon weighted ensemble model.

In an example embodiment, the source code file association system 105 tunes the weighted ensemble model with at least one of a max-base models parameter, a num_folds_parallel parameter, a max_base_models_per_type parameter, a use_orig_features parameter, a save_bag_folds parameter, a fold_fitting_strategy parameter. Illustrated below are the parameter values used for the Autogluon weighted ensemble model.

| Parameter | Value |
|---|---|
| max_base_models | 25 |
| num_folds_parallel | 4 |
| max_base_models_per_type | 5 |
| use_orig_features | True |
| save_bag_folds | True |
| fold_fitting_strategy | auto |

In an example embodiment, the project management tool 106 detects that at least one new integration test suite has been added to the plurality of integration test suites and in response, performs the steps of executing, capturing, preprocessing, and receiving. In other words, the source code file association system 105 iteratively associates integration test suites with the source code files that are exercised by those integration test suites each time additional integration tests are added to the integration test suites and/or every time a pull request is initiated. In an example embodiment, the source code file association system 105 dynamically maps the executed integration test suites to the source code exercised by those executed integration test suites, as those integration test suites are executed.

Accordingly, the particular processing operations and other functionality described in conjunction with the flow diagram of FIG. 2 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to significantly improve identification of the source code files exercised by the execution of integration test suites. These and other embodiments can effectively improve regression testing for each pull request relative to conventional approaches. For example, embodiments disclosed herein provide a method and a system for associating integration test suites with the source code files exercised by the execution of those integration test suites. Embodiments disclosed herein dynamically map the executed integration test suites to the source code exercised by those executed integration test suites, as those integration test suites are executed. Embodiments disclosed herein provide users with information regarding the specific source code exercised when the integration test suites are executed. Embodiments disclosed herein identify integration test suites so as to execute only those integration test suites that target the source code affected by individual code changes. Embodiments disclosed herein facilitate a more efficient Continuous Integration and Continuous Delivery/Deployment (CI/CD) lifecycle for individual code changes. Embodiments disclosed herein provide a mapping between the integration test suites, which often test very broad and complex functionality, and the associated source code files.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the information processing system 100. For example, containers can be used to implement respective processing devices providing compute and/or storage services of a cloud-based system. Again, containers may be used in combination with other virtualization infrastructure such as virtual machines implemented using a hypervisor.

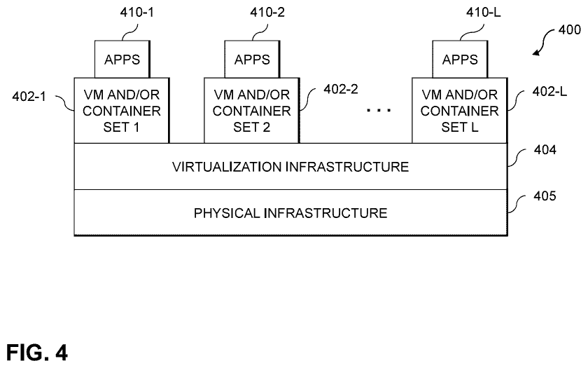

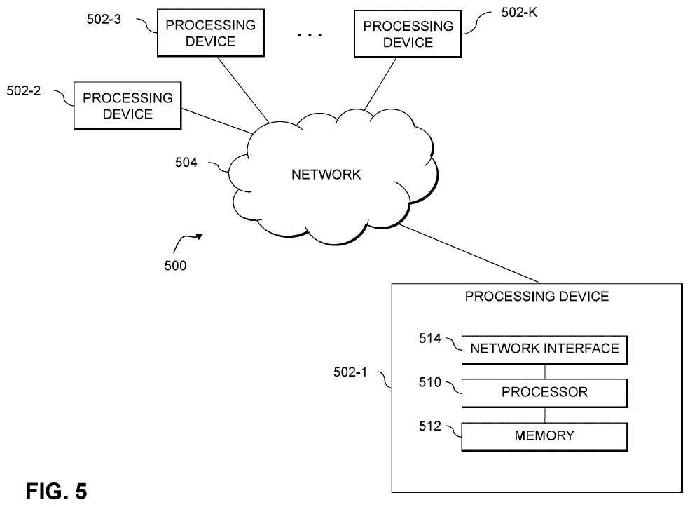

Illustrative embodiments of processing platforms will now be described in greater detail with reference to FIGS. 4 and 5. Although described in the context of the information processing system 100, these platforms may also be used to implement at least portions of other information processing systems in other embodiments.

FIG. 4 shows an example processing platform comprising cloud infrastructure 400. The cloud infrastructure 400 comprises a combination of physical and virtual processing resources that are utilized to implement at least a portion of the information processing system 100. The cloud infrastructure 400 comprises multiple virtual machines (VMs) and/or container sets 402-1, 402-2, . . . 402-L implemented using virtualization infrastructure 404. The virtualization infrastructure 404 runs on physical infrastructure 405, and illustratively comprises one or more hypervisors and/or operating system level virtualization infrastructure. The operating system level virtualization infrastructure illustratively comprises kernel control groups of a Linux operating system or other type of operating system.

The cloud infrastructure 400 further comprises sets of applications 410-1, 410-2, . . . 410-L running on respective ones of the VMs/container sets 402-1, 402-2, . . . 402-L under the control of the virtualization infrastructure 404. The VMs/container sets 402 comprise respective VMs, respective sets of one or more containers, or respective sets of one or more containers running in VMs. In some implementations of the FIG. 4 embodiment, the VMs/container sets 402 comprise respective VMs implemented using virtualization infrastructure 404 that comprises at least one hypervisor.

A hypervisor platform may be used to implement a hypervisor within the virtualization infrastructure 404, where the hypervisor platform has an associated virtual infrastructure management system. The underlying physical machines comprise one or more distributed processing platforms that include one or more storage systems.

In other implementations of the FIG. 4 embodiment, the VMs/container sets 402 comprise respective containers implemented using virtualization infrastructure 404 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of the information processing system 100 may each run on a computer, server, storage device or other processing platform element. A given such element is viewed as an example of what is more generally referred to herein as a “processing device.” The cloud infrastructure 400 shown in FIG. 4 may represent at least a portion of one processing platform. Another example of such a processing platform is processing platform 500 shown in FIG. 5.

The processing platform 500 in this embodiment comprises a portion of the information processing system 100 and includes a plurality of processing devices, denoted 502-1, 502-2, 502-3, . . . 502-K, which communicate with one another over a network 504.

The network 504 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 502-1 in the processing platform 500 comprises a processor 810 coupled to a memory 512.

The processor 510 comprises a microprocessor, a microcontroller, an application-specific integrated circuit (ASIC), a field-programmable gate array (FPGA) or other type of processing circuitry, as well as portions or combinations of such circuitry elements.

The memory 512 comprises random access memory (RAM), read-only memory (ROM) or other types of memory, in any combination. The memory 512 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 502-1 is network interface circuitry 514, which is used to interface the processing device with the network 804 and other system components, and may comprise conventional transceivers.

The other processing devices 502 of the processing platform 500 are assumed to be configured in a manner similar to that shown for processing device 502-1 in the figure.

Again, the particular processing platform 500 shown in the figure is presented by way of example only, and the information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
receiving, by a project management tool associated with a software test lifecycle system, a pull request to merge software code changes with a software project repository on an enterprise system;
executing, by the software testing life cycle system, a plurality of integration test suites associated with the pull request on at least one test system associated with the enterprise system, to test the software code changes;
in response to the executing, capturing, by the project management tool, integration test suite output;
preprocessing, by a source code file association system, the integration test suite output into preprocessed data for input into a machine learning system, wherein the integration test suite output is encoded; and
receiving, as output of the machine learning system, identification of at least a portion of source code exercised by the integration test suites, wherein the method is implemented by at least one processing device comprising a processor coupled to a memory.

2. The method of claim 1 further comprising:
detecting, by the project management tool, that at least one new integration test suite has been added to the plurality of integration test suites; and
in response, performing the steps of executing, capturing, preprocessing, and receiving.

3. The method of claim 1 wherein executing, by the software testing life cycle system, a plurality of integration test suites associated with the pull request comprises:
executing, by the software testing life cycle system, a plurality of pull requests, wherein a respective plurality of integration test suites is iteratively executed for each pull request.

4. The method of claim 1 wherein the integration test suite output comprises failures detected in a plurality of source code files during the execution of the plurality of integration test suites.

5. The method of claim 1 wherein capturing, by the project management tool, integration test suite output comprises:
exercising a remote API on a software repository to obtain source code file information for each of the plurality of source code files.

6. The method of claim 5 wherein the source code file information comprises at least one of:
source code file name;
a path of the source code file in the software repository;
a file type associated with the source code file name; and
at least one source code repository name.

7. The method of claim 5 further comprising:
performing one-hot encoding on the source code file information.

8. The method of claim 1 wherein capturing, by the project management tool, integration test suite output comprises:
obtaining integration test suite information comprising at least one of test name, test run status and pull request identifier.

9. The method of claim 8 further comprising:
using the pull request identifier to obtain source code file information.

10. The method of claim 8 further comprising:
performing one-hot encoding on the test name.

11. The method of claim 1 wherein preprocessing the integration test suite output into the preprocessed data comprises:
identifying a potential pattern of association between a subset of the plurality of source code files and the integration test suite output.

12. The method of claim 1 wherein preprocessing the integration test suite output into the preprocessed data comprises:
combining source code file information and integration test suite information into the preprocessed data; and
training the machine learning system with the preprocessed data.

13. The method of claim 12 wherein training the machine learning system with the preprocessed data comprises:
training the machine learning system with a subset of the preprocessed data; and
validating the machine learning system with a remaining subset of the preprocessed data, wherein the preprocessed data comprises the subset of the preprocessed data and the remaining subset of the preprocessed data.

14. The method of claim 1 wherein receiving, as output of the machine learning system, identification of the at least a portion of source code exercised by the integration test suites comprises:
running inference on the preprocessed data, using a weighted ensemble model to identify the portion of source code exercised by the integration test suites.

15. The method of claim 14 wherein the portion of source code comprises a plurality of source code files and wherein the output of the machine learning system associates at least one of the plurality of source code files exercised by at least one integration test suite, wherein the integration test suites comprise the at least one integration test suite.

16. The method of claim 14 wherein the weighted ensemble model is an AutoGluon weighted ensemble model.

17. The method of claim 14 further comprising:
tuning the weighted ensemble model with at least one of:
a max-base models parameter;
a num_folds_parallel parameter;
a max_base_models_per_type parameter;
a use_orig_features parameter;
a save_bag_folds parameter; and
a fold_fitting_strategy parameter.

18. A system comprising:
at least one processing device comprising a processor coupled to a memory;
the at least one processing device being configured:
to receive, by a project management tool associated with a software test lifecycle system, a pull request to merge software code changes with a software project repository on an enterprise system;
to execute, by the software testing life cycle system, a plurality of integration test suites associated with the pull request on at least one test system associated with the enterprise system, to test the software code changes;
in response to the executing, to capture, by the project management tool, integration test suite output;
to preprocess, by a source code file association system, the integration test suite output into preprocessed data for input into a machine learning system, wherein the integration test suite output is encoded; and
to receive, as output of the machine learning system, identification of at least a portion of source code exercised by the integration test suites.

19. The system of claim 18 further configured to:
detect, by the project management tool, that at least one new integration test suite has been added to the plurality of integration test suites; and
in response, perform the steps of executing, capturing, preprocessing, and receiving.

20. A computer program product comprising a non-transitory processor-readable storage medium having stored therein program code of one or more software programs, wherein the program code when executed by at least one processing device causes said at least one processing device:
to receive, by a project management tool associated with a software test lifecycle system, a pull request to merge software code changes with a software project repository on an enterprise system;
to execute, by the software testing life cycle system, a plurality of integration test suites associated with the pull request on at least one test system associated with the enterprise system, to test the software code changes;
in response to the executing, to capture, by the project management tool, integration test suite output;
to preprocess, by a source code file association system, the integration test suite output into preprocessed data for input into a machine learning system, wherein the integration test suite output is encoded; and
to receive, as output of the machine learning system, identification of at least a portion of source code exercised by the integration test suites.
